(19) United States
(12) Patent Application Publication
(10) Pub. No.: US 2018/0110265 A1
(43) Pub. Date: Apr. 26, 2018

(54) Swimming Trunks with Integrated, Discrete Inflatable Air Cells and Associated Control System

(71) Applicant: Patrick Symon, Murrells Inlet, SC (US)

(72) Inventor: Patrick Symon, Murrells Inlet, SC (US)

(21) Appl. No.: 15/331,334

(22) Filed: Oct. 21, 2016

(51) Int. Cl. A41D 7/00; H04W 4/00; A41D 13/012

(52) U.S. Cl. CPC A41D 7/003; H04W 4/008; H04W 84/12; A41D 13/0125; H04W 4/003

(57) ABSTRACT

The invention provides for a swimsuit with at least one discretely placed air cell positioned within a multi-part waistband of the swimsuit. Optionally, the swim suit also can include additional air cells placed within multi-part seams and hemlines with all air cells communicable coupled together. The swim suit is further outfitted with an CO2 gas cartridge with an actuator system that is also communicable coupled with the air cell or air cells. The actuator system can be actuated manually by the user using an actuator switch to open a valve or by sending wireless electronic systems from a remote transceiver. In addition, the multi-part waistband, seams, and hemlines may also include a synthetic rubber, such as neoprene either surrounding the air cells or positioned next to the air cells for added buoyancy.

### TECHNICAL FIELD

The present invention relates to the field of flotation devices and more specifically to swimming trunks with integrated, discrete, and inflatable and deflatable air cells that use a unique system for managing the inflation and deflation of the cells.

### BACKGROUND

Personal flotation devices come in many different sizes, shapes, and configurations that can be worn in many different ways, e.g. as a vest, belt, or arm and leg floaties, and may be constructed of materials that provide the buoyancy necessary to keep a swimmer afloat. In certain applications, the vest or belt may be constructed of materials such as synthetic rubbers that provide a degree of buoyancy. Other other applications, the vest, belt or floaties may be constructed of plastic materials that incorporate the use of air cells. The air cells can be filled with air either manually or using CO2 cartridges activated at an appropriate time.

Swimmers may use flotation devices when it is necessary but in some cases the swimmer may not always believe it to be necessary or simply may not desire to wear a flotation device. For example, when skiing or inner tubbing behind a boat or kayaking down a dangerous river, it is often necessary to wear a flotation device. However, it doesn't always mean the swimmer will use the flotation device in these cases. Other areas where the swimmer may not wear a flotation device because it is not deemed necessary but may at times need a flotation device is while surfing or simply swimming or wading or floating leisurely in waters.

An issue in theses cases is that there may be unknown dangers that can possible occur without notice. For example, a swimmer may simply become fatigued or is simply not experienced enough to handle the water and suddenly be in need of a flotation device. In addition, rivers and oceans can often become volatile without notice due to undercurrents or rip tides. In this case, the swimmer can easily be swept away by the force of the undercurrent or riptide which may cause the swimmer to panic and, possibly, become disoriented. If the swimmer doesn't have a flotation device or cannot properly activate the flotation device, e.g. due to disorientation, the result can be fatal.

A problem with personal flotation devices is that they are not always discrete or may be otherwise cumbersome to wear which essentially provides motivation for a swimmer not to wear a flotation device even when needed. A specific problem with flotation devices that use CO2 cartridges that can be activated by the swimmer is that may be panic, disoriented, e.g. when exposed to riptides, or simply too fatigued to activate the CO2 cartridges.

As such, there is a need for a swimsuit that employs the use of discretely placed air cells with the air cells capable of being inflatable in a more simplified manner.

### SUMMARY

The example embodiments presented herein meet the above-identified needs by providing a swimsuit with at least one discretely placed air cell positioned around a multi-part waistband of the swimsuit. Optionally, the swim suit also can include additional air cells placed along multi-part seams and hemlines with all air cells communicable coupled together. The swim suit is further outfitted with an CO2 gas cartridge with an actuator system that is also communicable coupled with the air cell or air cells. The actuator system can be actuated manually by the user using an actuator switch to open a valve or by sending wireless electronic signals from a remote transceiver to open the valve.

In addition, the multi-part waistband, seams, and hemlines may also include a synthetic rubber, such as neoprene either surrounding the air cells or positioned next to the air cells for added buoyancy.

### BRIEF DESCRIPTION OF THE DRAWINGS

FIG. 1 is a front view of a swimming trunk with air cells, synthetic rubbers, and other materials according to an embodiment of the invention.

FIG. 2 is a front and back view of a housing unit with a CO2 cartridge stored therein and an actuator releasing compressed air into the air cells according to an embodiment of the invention.

FIG. 3 is a system diagram of a radio transmitter for sending signals to the actuator according to an embodiment of the invention.

FIG. 4 is a system diagram of a radio receiver for use with the actuator and for receiving signals from the radio transmitter according to an embodiment of the invention.

### DETAILED DESCRIPTION

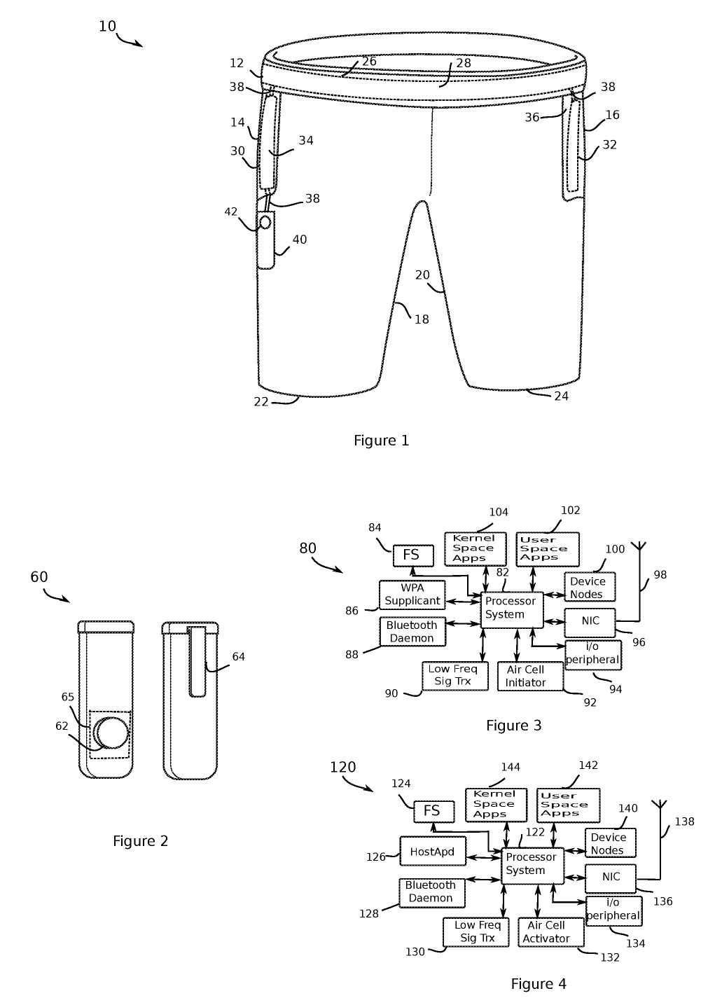

Referring to FIG. 1, illustrated is a swimsuit with strategically positioned flotation aids and a CO2 gas cartridge and actuator system denoted generally as 10. The swimsuit 10 includes a multi-part waistband 12, multi-part outer seams 14,16, multi-part inner seams 18,20, and multi-part hemlines 22,24. Multi-part in this context refers to the material along the multi-part sections being compartmentalized so that component pieces can be placed within the waistband or seemed areas. It should be understood, however, that not all the seams need be multi-part. For example, the waistband 12 and the outer seams 14,16 may be adequate. However, it is the use of the multi-part waistband and seams and the components used within the compartmentalized sections that allows for a swimsuit that can discretely use flotation assistant devices.

The swimsuit 10 further includes within the multi-part waistband 12 an air cell, or bladder, 26 and, optionally, a synthetic rubber 28, e.g. neoprene. The combination of the two providing enhanced buoyancy. In addition, the outer seams 14,16 may also include air cells 30,32 and, optionally, a synthetic rubber 34,36, e.g. neoprene. As stated previously, the inner seams 18,20 and the hemlines 22,24 may also have air cells and synthetic rubbers used therein. In any case, the air bladders include an air flow channel 38 communicable coupled with the air cell system and a compressed CO2 gas cylinder and housing unit 40. The housing unit 40 includes an actuator system 42 that controls opening and closing a valve for releasing CO2 gas and discharging the released gas when no longer needed. The actuator system may be manually operated, e.g. by turning the actuator nob clockwise or counter clockwise or, optionally, remotely using radio communication signals.

Referring now to FIG. 2, illustrated is a front view of CO2 cartridge housing unit and actuator system and back view of the CO2 cartridge housing unit denoted generally as 60. The CO2 cartridge housing unit 60 includes a CO2 cartridge, not illustrated, housed within the housing unit 60, an actuator button 62, and a clip 64 for clipping to the swimsuit 10 and, optionally, an actuator system 65, see FIG. 4. The actuator button 62 and system 65 operate to control a valve that can penetrate the CO2 cartridge. For example, a linear microactuator may be used to penetrate the cartridge, either manually or remotely using radio communication signals. In addition, the actuator button 62 can also be rotated in a direction which results in the release of air from the air cells. The CO2 cartridge can be any commercially available cartridge, such as Mosa® or Kayser®. There are many manufactures of microactuators and the specifics of the interface between actuator and valve control are not the focus to the invention.

In the subsequent discussions in reference to FIGS. 3 and 4, a remote control system will be discussed that describes the use of radio transceivers to communicate with the the actuator system in order to activate the inflation of the air cells. As stated previously in the background, this could be important when a swimmer becomes discombobulated, e.g. if swimmer is caught in a riptide or a small child is suddenly overwhelmed. In either case, the actuator system can be actuated by a third party, such as a mother monitoring her child from a remote location, or by the swimmer, e.g. using a wristwatch, which may be easier to use than trying to find the actuator switch in an unfamiliar location when in a confused or panicked state.

Referring now to FIG. 3, illustrated is a transceiver system for interfacing with and remotely controlling an actuator system of the housing unit 60 and is denoted generally as 80. The transceiver system 80 includes a processor system 82, a file system 84, a Wi-Fi Wireless Point Access (WPA) supplicant 86, a Bluetooth daemon 88, a low frequency radio signal transceiver 90, an air cell initiator application 92, an I/O peripheral interfaces 94, a Network Interface Card (NIC) 96 and antenna 98, device nodes 100, user space applications 102, and kernel space applications 104. In addition, the low frequency radio signal transceiver 90 may be a ham radio signal generator that generates signals in the ham radio frequency range.

The transceiver system 80 described is a standard Linux® platform and all the necessary components needed to perform the basic functionality of communications is presented. The use of the necessary components and the air cell initiator application 92 provides full functionality for communications and control. The cell initiator application 92 will be discussed in more detail below. Furthermore, the processing system 82 may include a central processing unit, memory, and a system bus. The device nodes 100 and I/O peripheral system may include but is not limited to a hard drive, a touch screen, a keyboard, and a USB device.

The cell initiator application 92 functions in a manner to constantly or periodically listen to broadcast signals from a compatible application and in response to receiving the appropriate broadcast signal, stores and registers an application identifier for further use. The application identifier may be provided by the remote transceiver or may be already known and pre-stored. Optionally, the cell initiator application 92 may in response to receiving a compatible application identifier, send its own application identifier. The cell initiator application 92 further functions so that upon user input the cell initiator application 92 engages at least one of the WPA supplicant 86, Bluetooth daemon 88, or low frequency signal transceiver to send to an actuation signal with an application identifier.

In the case the Wi-Fi channel is used, the wpa_supplicant 86 can easily authenticate with the remote receiver using an application identifier that will result in activation of the actuator system upon receipt by the receiving system. The same can be said for the use of Bluetooth and the ham radio system. The radio signals transmitted for activation are likely to occur with the swimsuit 10 is underwater. Although radio signals do not penetrate very deeply below the waters surface, depending on the wavelength can penetrate three to nine feet. In fresh water lakes, e.g., the signals will have better penetration and in salt water systems the signal penetration may be less. However, that is the reason for the various radio frequency communication platforms used. Obviously, the lower frequency signals will penetrate more deeply and as such the low frequency transceiver, such as a ham radio, may be the best and only option.

Referring now to FIG. 4, illustrated is an actuator transceiver system of housing unit 60 for interfacing with transceiver system 80 and is denoted generally as 120. The actuator transceiver system 120 includes a processor system 122, a file system 124, a WI-FI Host Access point daemon (HostApd) 126, a Bluetooth daemon 128, a low frequency radio signal transceiver 130, an air cell activator application 132, an I/O peripheral interfaces 134, a Network Interface Card (NIC) 136 and antenna 138, device nodes 140, user space applications 142, and kernel space applications 144. In addition, the low frequency radio signal transceiver may be a ham radio signal generator that generates signals in the ham radio frequency range.

The actuator transceiver system 120 described is a standard Linux® platform and all the necessary components needed to perform the basic functionality of communications is presented. The use of the necessary components and the air cell activator application 92 provides full functionality needed for communications and control, which will be discussed in further detail below. Furthermore, the processing system 122 may include a central processing unit, memory, and a system bus. The device nodes 100 and I/O peripheral system may include but is not limited to a hard drive, a touch screen, a keyboard, and a USB device.

The air cell activator application 132 functions in a manner to constantly or periodically send, e.g. upon user request, broadcast signals with an application identifier to a compatible application, e.g. the air cell initiator application 92, and, optionally, in response to receiving an acknowledgement signal with an application identifier, stores and registers the application identifier for further use. The application identifier may be provided by the air cell initiator application 92 of remote transceiver 80 or may be already known and pre-stored. The cell activator application 132 also continuously monitors for an activation signal, either a broadcast activation signal or addressed directly to activator application 132. The monitoring is done over at least one of HostApd, in the invent of Wi-Fi use, Bluetooth daemon, or low frequency transceiver in the event ham radio signals are used, e.g. Upon receipt of the activation signal, the air cell activator application 132 sends a signal to the actuator system 65 to engage control of the actuator valve.

Referring now to FIG. 5, illustrated is a process flow diagram describing the process steps for controlling and managing the transceiver system 80 that is used to remotely interface with and remotely control the actuator transceiver system 120 and is denoted generally as 160.

The process flow diagram 160 begins at step 162 where a user requests to pair or communicate with a remote actuator transceiver system. If a broadcast signal with an application identifier is received, as determined at step 164, the application identifier is stored, at step 166. Other wise, the process loops back to the begin state. If the broadcast signal is received and stored, the process logic determines if a user of the transceiver system 80 is requesting that an actuator signal be sent the transceiver system 120 associated with the stored application identifier, step 168. If the user requests such, a signal is generated and sent, at step 170. If the user does not request such, the process logic loops continuous in a monitoring state. Upon the signal being sent, the process returns to it beginning state.

Referring now to FIG. 6, illustrated is a process flow diagram describing the process steps of air cell activator 132 of transceiver 120 that controls and manages the communications and processing between transceiver 80 and the actuator system 65. The process flow diagram is denoted generally as 180.

The process flow diagram 180 begins at step 182 where the actuator transceiver system 120 generates a broadcast signal, e.g. upon user input or automatically. The transceiver system 120, in response, sends a broadcast signal with an application identifier to the transceiver system 80, step 184. The process flow continues at step 186 where the transceiver system 120 continuously monitors for an actuator signal with the application identifier. If an actuator signal with the application identifier is received, a signal is generated and sent to the actuator system to open the control valve, step 188, and upon sending the signal the process returns to its beginning state.

Thus, While there have been shown and described and pointed out fundamental novel features of the invention as applied to a preferred embodiment thereof, it will be under stood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same Way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A swimsuit comprising:
a multi-part waistband with an inner wall and an outer wall coupled together and an air cell with an air delivery channel positioned between the inner wall and outer wall;
a material lining connected to the multi-part waistband with the material lining have inseams, outer seams, and a hemline connecting the inseams and outer seams; and
a housing unit with a compressed CO2 gas cylinder and a user operated actuator system for activating the gas cylinder, the housing unit attachable to the material lining and the gas cylinder communicable coupleable with the air delivery channel of the multi-part waistband.

2. The swim suit as recited in claim 1 wherein at least one of the inseams, outer seams, and hemline are multi-part and have an inner wall and outer wall coupled together and an air cell with an air delivery channel positioned between the inner wall and outer wall and communicable coupled with the air delivery channel of the multi-part waistband.

3. The swim suit as recited in claim 2 wherein the at least one multi-part waistband, inseams, outer seams, and hemline include positioned within the inner and outer wall a synthetic rubber for aiding in buoyancy.

4. The swimming suit as recited in claim 1 wherein the user actuator system is a release valve operable to release compressed air into the air cells.

5. The swimming suit as recited in claim 2 wherein the user actuator system includes a radio frequency receiver for receiving radio waves and is actionable in releasing the valve in response to receiving radio waves of a predefined frequency range wherein the radio waves include an encoded application identifier identifying the actuator system.
